(19) United States
(12) Patent Application Publication
(10) Pub. No.: US 2005/0281480 A1
(43) Pub. Date: Dec. 22, 2005

(54) Computer apparatus and method for generating a paint-by-number picture from a digital image

(76) Inventor: Robert A. Baldwin, Phoenix, AZ (US)

Correspondence Address: MARTIN & ASSOCIATES, LLC, P O BOX 548, CARTHAGE, MO, 64836-0548, US

(21) Appl. No.: 10/872,183

(22) Filed: Jun. 18, 2004

(51) Int. Cl. G06K 9/36; G06F 15/00; G09G 5/02

(52) U.S. Cl. 382/276; 358/1.9; 345/589

(57) ABSTRACT

A computer apparatus and method process a digital image according to a set of selected colors, and generate from the digital image a paint-by-number image. The set of selected colors may be manually selected one at a time by a user, or a predefined set of colors may be selected by a user. Predefined sets of colors may include commercially-available paint sets, crayon sets, colored marker sets, and colored pencil sets. In this manner, a user may take a digital image (such as a digital photograph of grandma or the family pet), select a particular paint or crayon set, and generate a paint-by-number picture of the digital image that is customized to the selected paint or crayon set. The resulting paint-by-number picture may include a legend that correlates the characters on the paint-by-number picture that represent color to the corresponding colors in the set of selected colors. The preferred embodiments also include a method for doing business that includes processing a customer-selected digital image according to a customer-selected color set, and outputting the resulting paint-by-number picture to the customer. Another method for doing business within the scope of the preferred embodiments is selling a product that defines a set of colors, such as a paint set or a crayon set, with software that includes the image processor of the preferred embodiments that allows generating paint-by-number pictures that are customized to the colors in the product.

### BACKGROUND OF THE INVENTION

1. Technical Field

This invention generally relates to data processing, and more particularly relates to the processing of digital images in a computer system.

2. Background Art

Paint-by-number pictures have been known for decades. A paint-by-number picture is typically a collection of different-shaped regions, with each region including a number that indicates the color to color each region. The regions are typically defined using black lines on white paper. A user (especially children) can then select a color that corresponds to a particular number, and color all the regions with that number the same color. The user then selects a different color and colors all the regions with that number with the selected color. This process continues until all the regions in the paint-by-number picture have been colored with the colors that correspond to the numbers. Note that the term “paint-by-number” as used herein denotes the practice known in the art of outlining regions and marking those regions with a number or other symbol that defines what color the user should color that region, regardless of whether the user colors the picture with paint, markers, crayons, etc.

Most known paint-by-number pictures are hard-copy pictures that are generated from scratch and placed in a child's activity book with other pictures, such as pictures to color, connect-the-dot pictures, etc. With the increasing popularity of digital photography, it would be desirable to be able to create a paint-by-number picture from a photograph taken with a digital camera, or from any other digital image. Therefore, there existed a need to provide a computer apparatus and method for automatically generating a paint-by-number picture from a digital image.

### DISCLOSURE OF INVENTION

According to the preferred embodiments, a computer apparatus and method process a digital image according to a set of selected colors, and generate from the digital image a paint-by-number image. The set of selected colors may be manually selected one at a time by a user, or a predefined set of colors may be selected by a user. Predefined sets of colors may include commercially-available paint sets, crayon sets, colored marker sets, and colored pencil sets. In this manner, a user may take a digital image (such as a digital photograph of grandma or the family pet), select a particular paint or crayon set, and generate a paint-by-number picture of the digital image that is customized to the selected paint or crayon set. The resulting paint-by-number picture may include a legend that correlates the characters on the paint-by-number picture that represent color to the corresponding colors in the set of selected colors. The preferred embodiments also include a method for doing business that includes processing a customer-selected digital image according to a customer-selected color set, and outputting the resulting paint-by-number picture to the customer. Another method for doing business within the scope of the preferred embodiments is selling a product that defines a set of colors, such as a paint set or a crayon set, with software that includes the image processor of the preferred embodiments that allows generating paint-by-number pictures that are customized to the colors in the product.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a gray-scale digital image of a horse head;

FIG. 2 is an outline of regions in the digital image of FIG. 1 that are defined according to a particular set of selected colors;

FIG. 3 is a paint-by-number picture that is generated from the digital image of FIG. 1 by assigning numbers to each color in the set of selected colors to each corresponding region shown in FIG. 2;

FIG. 4 is a diagram of a legend for the paint-by-number picture of FIG. 3;

FIG. 5 is a flow diagram of a method for generating a paint-by-number picture in accordance with the preferred embodiments;

FIG. 6 is a flow diagram of a first way to select a set of colors in step 520 of FIG. in accordance with the preferred embodiments;

FIG. 7 is a flow diagram of a second way to select a set of colors in step 520 of FIG. 5 in accordance with the preferred embodiments;

FIG. 8 is a flow diagram of a third way to select a set of colors in step 520 of FIG. 5 in accordance with the preferred embodiments;

FIG. 9 is a flow diagram of a method for dynamically displaying a paint-by-number picture as changes are made to its set of selected colors;

FIG. 10 is a flow diagram of a first method for doing business using the apparatus and method of the preferred embodiments;

FIG. 11 is a flow diagram of a second method for doing business using the program product of the preferred embodiments; and

FIG. 12 is a block diagram of an apparatus in accordance with the preferred embodiments.

### BEST MODE FOR CARRYING OUT THE INVENTION

The preferred embodiments allow a paint-by-number picture to be generated from any digital image according to a set of colors specified by a user. The colors may be selected one at a time by the user, or may be selected as a group of predefined colors. These predefined colors may correspond to commercially-available products, such as a paint program, a paint set, a crayon set, a colored marker set, a colored pencil set, etc. The preferred embodiments thus allow generating a paint-by-number picture for any digital image that is customized according to the selected colors.

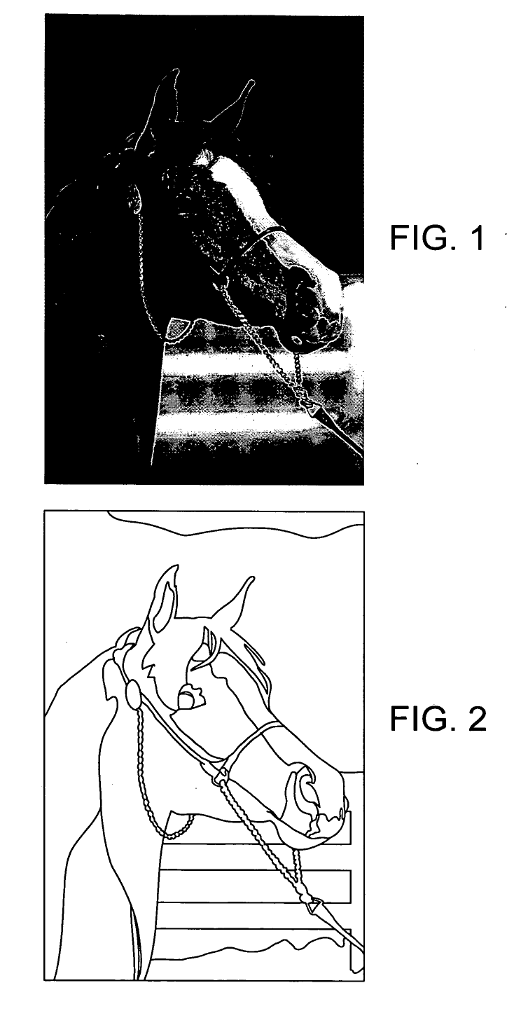

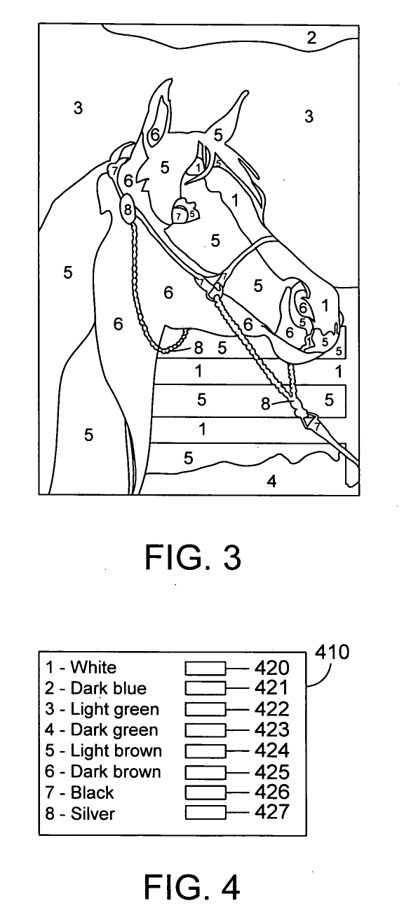

FIG. 1 is a hard-copy printout of a digital image of a horse head. The digital image from which this horse head was derived was in color. However, due to limitations in patent drawings, the gray-scale version shown in FIG. 1 will be used to illustrate the preferred embodiments. The apparatus and method of the preferred embodiments process the digital image of FIG. 1 to generate therefrom a new digital image as shown in FIG. 2 that includes regions that correspond to a set of selected colors. For the specific example of FIG. 2, we assume that eight colors are selected, namely: white, dark blue, light green, dark green, light brown, dark brown, black, and silver. The outlines in FIG. 2 are a function of the specific number of colors and the specific colors selected. Once the outlines are defined in the new image, characters are assigned to these regions, as shown in FIG. 3. For the eight selected colors above, number 1 corresponds to white; number 2 corresponds to dark blue; number 3 corresponds to light green; number 4 corresponds to dark green; number 5 corresponds to light brown; number 6 corresponds to dark brown; number 7 corresponds to black; and number 8 corresponds to silver. Note that some regions, such as the chains in FIG. 3, may be too small to enclose a character that specifies a corresponding color, and these regions may be identified by a character with a line pointing to the region, as shown in two places for the number 8 in FIG. 3.

While the regions in FIG. 3 are shown to be marked with a number, it is equally within the scope of the preferred embodiments to leave one or more regions blank. Leaving regions blank may be useful, for example, for the white regions (marked with a 1) in FIG. 3, assuming that the image in FIG. 3 will be printed on white paper, which will be the most common case. In addition, other characters and symbols (besides numbers) may be used to denote colors. The preferred embodiments expressly extend to any type of marking that represents a color in any and all regions of a processed digital image.

Referring to FIG. 4, the preferred embodiments also extend to the creation of a legend 410 that correlates each character used in the paint-by-number picture with its corresponding color. In one implementation, the legend 410 may be a simple legend that correlates the characters to the preferred name of a color, such as 1-White, 2-Dark blue, etc. In another implementation, the characters may be correlated to a color patch (e.g., 420-427) that shows a sample of the color that corresponds to the character. Thus, the color patch 420 would be white, color patch 421 would be dark blue, etc. By incorporating color into the legend 410, a user can determine from the color whether he or she has a corresponding color available. This may be particularly useful in the case of colored pencils or markers that do not have specific names of colors. In the alternative, if the set of colors selected in step 520 correlate to colors in a product (such as a paint program, paint set, crayon set, colored marker set, colored pencil set, etc.), the legend may include the specific names of colors used in the product. Thus, if an eight crayon set is selected as the defined set of colors in step 520, the legend may correlate the specific color names on the crayons to the characters used to mark the regions. Note that the legend could be printed out on a separate sheet,.could be printed out on the back of the sheet used to print the new image, or may be included within the new image itself.

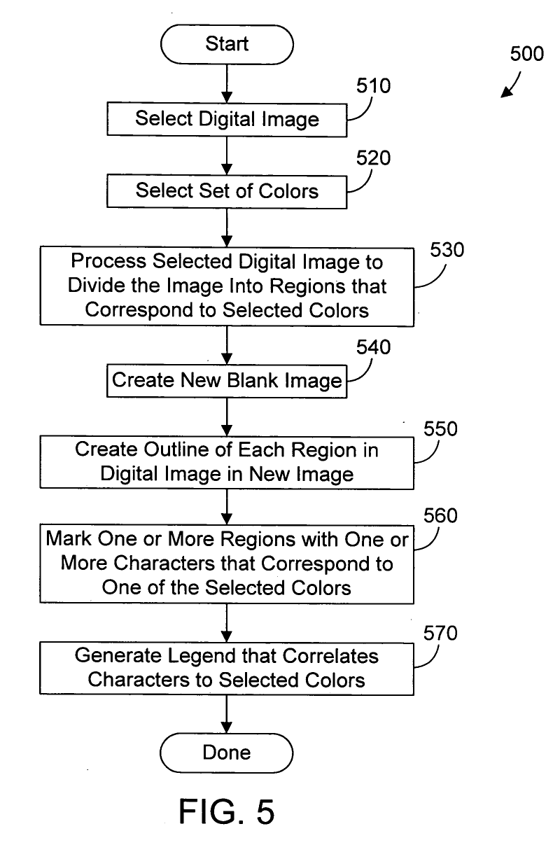

Referring now to FIG. 5, a method 500 in accordance with the preferred embodiments begins by selecting a digital image (step 510). The digital image may be from any suitable source, such as a scanner, digital camera, a diskette, a CD-ROM, a web site, etc. Next, a set of colors is selected (step 520). There are various ways to select a set of colors in step 520, which are discussed in more detail below. Note that steps 510 and 520 could be reversed, with the set of colors being selected first and the digital image selected second. Once the digital image and set of colors have been selected, the digital image is processed to divide the digital image into regions that correspond to the colors in the set of selected colors (step 530). This processing is done by analyzing the colors of regions and comparing the color of each region to the colors in the set of selected colors. The region is then assigned one of the colors in the set of selected colors based on how close the color of that region in the selected digital image matches the colors in the set of selected colors.

A new image is then created (step 540) that is initially blank. Next, an outline of each region defined in the processed digital image is created in the new image (step 550). One or more regions are then marked with one or more characters that correspond to one of the selected colors (step 560). In the most preferred embodiments, each region is marked in step 560. However, it is equally within the scope of the preferred embodiments, as discussed above, to not mark one or more of the regions. Finally, a legend is generated that correlates the characters used to mark the regions with the corresponding selected colors (step 570), such as legend 410 of FIG. 4.

Referring back to FIGS. 1-4, we assume that the digital image of FIG. 1 (in color) is selected in step 510, and that the eight colors listed above are selected in step 520. Step 550 generates the image in FIG. 2, step 560 generates the image in FIG. 3, and step 570 generates the legend in FIG. 4.

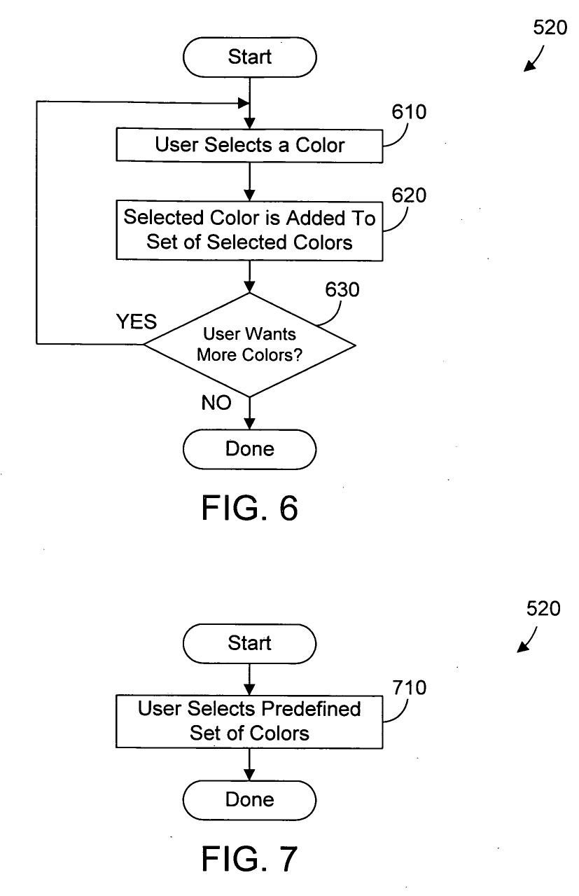

FIG. 6 shows steps that could be executed in step 520 of FIG. 5 for one possible way to select a set of colors within the scope of the preferred embodiments. First, a user selects a color (step 610), preferably from a palette of colors on a computer system. The selected color is then added to the set of selected colors (step 620). If the user wants more colors (step 630=YES), the user may repeat steps 610 and 620 until the user does not want any more colors (step 630=NO). The steps in FIG. 6 show how a user could select colors one at a time. This would allow a user to define a unique set of colors. For example, the user could turn any digital image into a Halloween-looking image by selecting the colors of black, orange, and white.

A second way to select a set of colors in step 520 within the scope of the preferred embodiments is for a user to select a predefined set of colors, shown as step 710 in FIG. 7. The predefined set of colors could correspond to different themes. For example, the colors of black, orange and white (mentioned above) could be in a predefined set called “Halloween colors”. Similarly, fall colors, such as brown, black, orange, yellow, rust, and red could be in a predefined set called “fall colors”. Step 710 extends to a user selecting any predefined group of colors. Note that the term “predefined” does not necessarily mean that the group was defined by a third party. The user could select the individual colors of black, orange and white, and could store these colors as a predefined set called “Halloween colors”. Once stored as a predefined set, the predefined set could be selected in step 710.

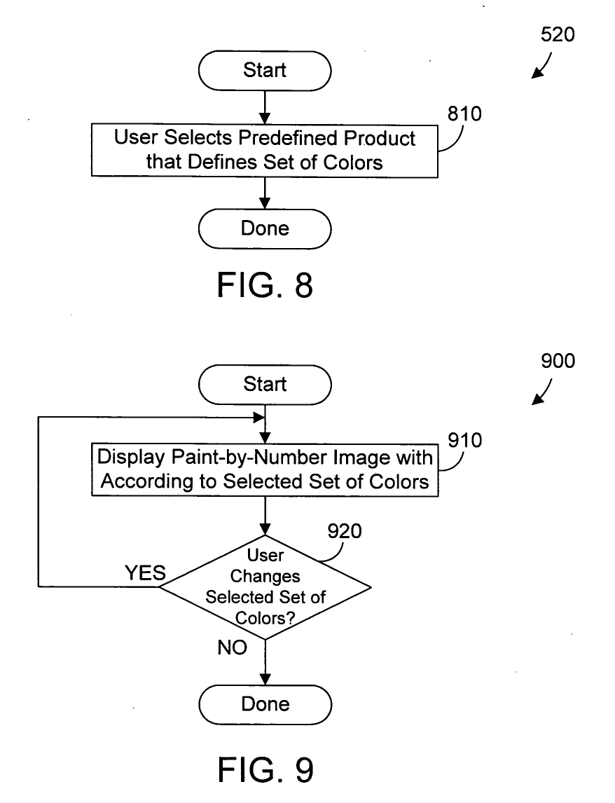

A third way to select a set of colors in step 520 within the scope of the preferred embodiments is for a user to select a predefined product that defines a set of colors, shown as step 810 in FIG. 8. This is particularly useful in generating paint-by-number pictures that use colors in commercially-available products. Thus, in step 810 the user could select an eight color crayon set as the predefined product. The colors for this predefined product are stored within the computer system, and are selected as the defined set of colors for processing a digital image. The result will be a paint-by-number picture that is customized to the colors in the selected predefined product. Note that the predefined product extends to any product that specifies multiple colors, including without limitation a computer software paint program, a paint set, a crayon set, a colored marker set, and a colored pencil set. Step 810 allows a user to simply specify the product they have available to color the paint-by-number picture, and the paint-by-number picture will then be customized to the set of colors available in that product. Thus, if a user specifies a particular eight crayon set in step 810, the resulting paint-by-number picture will be customized to the eight colors in the specified eight crayon set. If, however, the user has a sixty-four crayon set, the user may select the sixty-four crayon set in step 810, and the resulting paint-by-number picture will have many more regions with many more colors due to the larger number of available colors. Note also that the legend (referenced in FIG. 4 and in step 570 of FIG. 5) may correlate the characters used to mark the regions with the corresponding name of the crayon colors in the set.

One advantage of the preferred embodiments is the ability to dynamically change the set of selected colors and see the effect on the paint-by-number image displayed to the user. This ability is represented as method 900 in FIG. 9. A paint-by-number image is displayed according to the set of selected colors (step 910). If a user changes the set of selected colors (step 920=YES), method 900 loops back to step 910, which displays the paint-by-number image according to the new set of selected colors. Method 900 thus provides a real-time feedback mechanism that allows a user to select how the final paint-by-number image may look. Note that the display of the paint-by-number image in step 910 may be a black-and-white version (such as that shown in FIG. 3), showing the change in the regions that result from a change in the set of selected colors, or could be in color, showing the changes that result in the final image once colored. The usefulness of method 900 may be illustrated using a simple example. Let's assume that a young boy has a digital image of grandma that he wants to color. The boy may select a set of color that corresponds to a crayon set he has, and may then view how the final image will look based on those colors. The boy may then select a different crayon set (or a pencil set, paint set, etc.), or may select additional colors or remove colors from the selected color set to see how the paint-by-number image (or final image) is affected by the change in colors. If an image does not look the way the boy thinks it should, the set of selected colors may be changed until the paint-by-number image has the desired look.

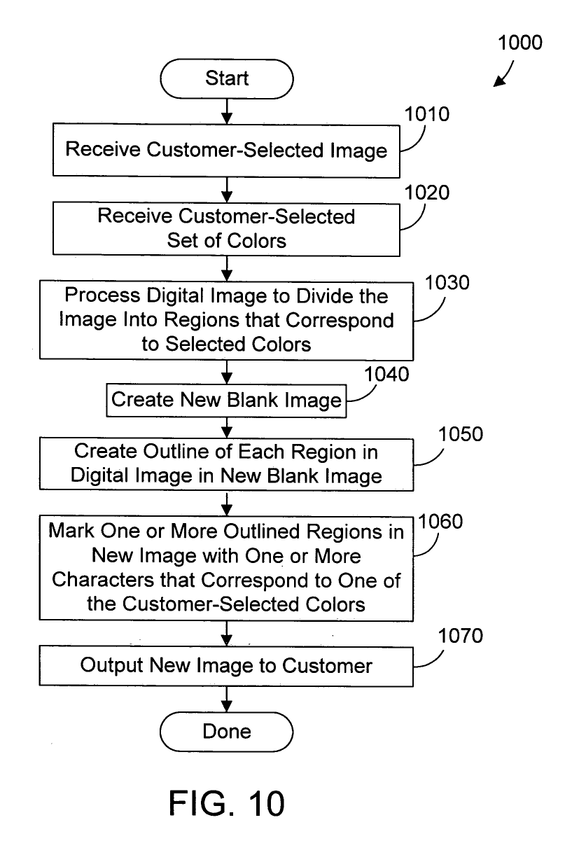

The preferred embodiments include methods for doing business. Referring to FIG. 10, a method 1000 for doing business begins by receiving a customer-selected image (step 1010). This image may be a digital image received directly from the customer, such as in an attachment to an e-mail message, or may be received from another source, such as a web site, based on a web address provided by the user. In addition, this image may be a hard-copy image that is scanned to generate therefrom a digital image. Next, the customer-selected set of colors is received (step 1020). Note that various ways for the customer to select a set of colors within the scope of the preferred embodiments are discussed above with reference to FIGS. 6-8. Note that the order of steps 1010 and 1020 could be reversed. Once the digital image and set of colors are received, the digital image is processed to divide the image into regions that correspond to selected colors (step 1030). Next, a new blank image is created (step 1040). An outline of each region in the digital image is then created in the new image (step 1050). Note that the number of regions will be determined in large part by the number of colors in the customer-selected set of colors. Once the regions are defined in the new image, one or more outlined regions are marked with one or more characters that correspond to one of the customer-selected colors (step 1060). The image is then output to the customer (step 1070). Note that step 1070 may include printing the image in hard-copy form and sending the hard-copy to the customer, and may also include sending the new image in digital form to the customer electronically, such as via e-mail, or sending a slide to the customer that may be projected on a wall or other surface. The method of doing business 1000 allows a business to provide the service of converting any digital image into a paint-by-number image in a variety of forms for the customer.

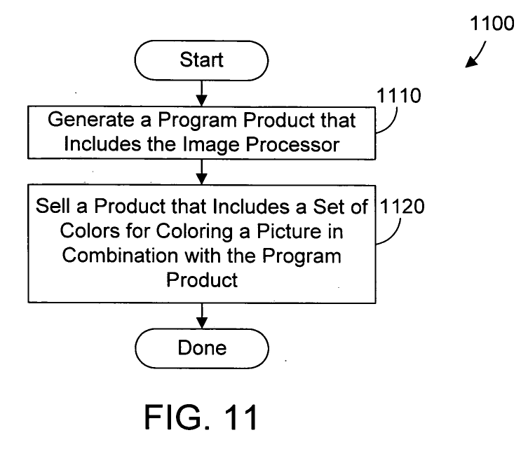

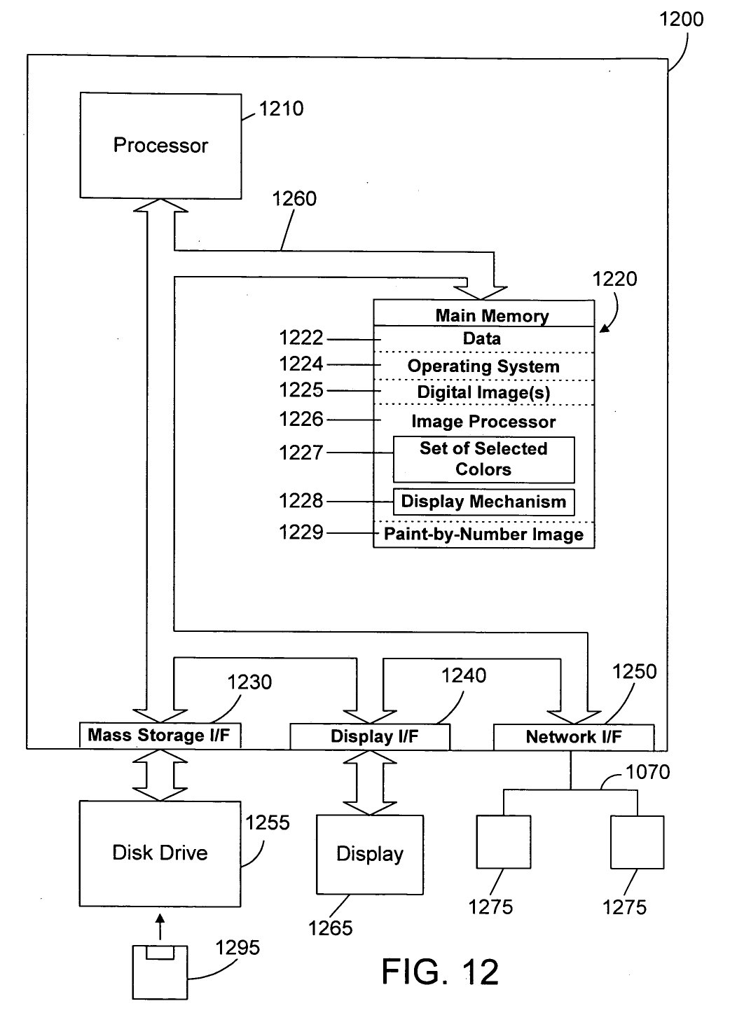

A second method for doing business within the scope of the preferred embodiments is shown as method 1100 in FIG. 11. A program product is generated that includes an image processor (step 1110). The image processor is discussed in more detail below with reference to FIG. 12. A product that includes a set of colors for coloring a picture may then be sold in combination with the program product (step 1120). One example within the scope of method 1100 is to provide an image processor of the preferred embodiments on a floppy disk, and selling the floppy disk in combination with a product that has a set of colors, such as a computer software paint program, a paint set, a crayon set, a colored marker set, a colored pencil set, etc. The program product will preferably be customized to allow the user to select the product to select the predefined colors in the product. Thus, a floppy disk with the image processor of the invention could be sold as a bonus with a set of sixty-four crayons. The user could use the image processor to generate a paint-by-number picture that corresponds to the sixty-four defined colors in the crayon set. Of course, other variations are possible within the scope of the preferred embodiments. For example, a computer software paint program could include the image processor of the preferred embodiments, and both could be downloaded via transmission media, such as downloaded from a web site. Method 1100 expressly extends to the bundling of a program product that includes an image processor with any product that includes a set of colors.

Referring now to FIG. 12, a computer system 1200 is one suitable implementation of an apparatus in accordance with the preferred embodiments of the invention. Computer system 1200 is preferably an IBM-compatible personal computer system. However, those skilled in the art will appreciate that the mechanisms and apparatus of the present invention apply equally to any computer system, regardless of whether the computer system is a complicated multi-user computing apparatus, a single user workstation (such as a personal computer), or an embedded control system. As shown in FIG. 12, computer system 1200 comprises a processor 1210, a main memory 1220, a mass storage interface 1230, a display interface 1240, and a network interface 1250. These system components are interconnected through the use of a system bus 1260. Mass storage interface 1230 is used to connect mass storage devices (such as a disk drive 1255) to computer system 1200. One specific type of disk drive 1255 is a floppy disk drive, which may store data to and read data from a floppy disk 1295.

Main memory 1220 in accordance with the preferred embodiments contains data 1222, an operating system 1224, one or more digital images 1225, an image processor 1226, and a paint-by-number image 1229. The image processor 1226 includes a set of selected colors 1227, and processes a digital image 1225 according to the set of selected colors 1227. Image processor 1226 also includes a display mechanism 1228 that allows a user to see changes to a paint-by-number image as the number of colors in a color set are varied or as the colors themselves are changed, as described above with reference to FIG. 9. Image processor 1226 preferably performs the steps 530-570 of FIG. 5, and either provides a user interface that allows the user to perform the selections in steps 510 and 520, or otherwise receives from the user the selection of the digital image in steps 510 and the selection of the set of selected colors 1227 in step 520. Image processor 1226 preferably also provides a user interface or other required support to perform the steps in FIGS. 6-8 and to perform the method of doing business I 000 in FIG. 10. As stated above, the program product referenced in method 1100 of FIG. 11 preferably includes the image processor 1226 on a signal bearing media, such as recordable media or transmission media.

The image processor 1226 processes a digital image 1225 according to the set of selected colors 1227 and generates therefrom a new image, referred to in FIG. 12 as a paint-by-number image 1229. Note that the term “paint-by-number image” does not mean an image that must be painted, but instead means any image with uncolored regions that include one or more characters, symbols, or other markers that indicate what color those regions should be. In the most preferred embodiment, the paint-by-number image 1229 is an image that include black lines that outline the regions, and black characters within those regions (or pointing to those regions) that indicate the color each region should be colored. When printed on a white sheet of paper, the paint-by-number image 1229 can then be colored using a paint set, crayons, colored markers, colored pencils, etc. When output to a computer software paint program, the paint-by-number image 1229 can be colored using the palette of colors and mouse common in paint programs. While the preferred implementation uses black lines on a white or otherwise neutral background, it is equally within the scope of the preferred embodiments to provide colored lines, including a combination of different colored lines, and could also include colored backgrounds. The preferred embodiments also extend to light gray lines or lines printed in an ink that is only visible under a certain light, allowing a paint-by-number picture to be colored without the region lines and characters being visible in the finished picture. The preferred embodiments also extend to lines printed on a transparent overlay, and to lines printed on a slide that may be projected on a wall or other surface. The preferred embodiments expressly extend to any suitable representation of a paint-by-number image 1229 that could be generated by the image processor 1226 using the methods of the preferred embodiments disclosed herein and a reasonable range of equivalents thereto.

Computer system 1200 utilizes well known virtual addressing mechanisms that allow the programs of computer system 1200 to behave as if they only have access to a large, single storage entity instead of access to multiple, smaller storage entities such as main memory 1220 and disk drive 1255. Therefore, while data 1222, operating system 1224, digital images 1225, image processor 1226, and paint-by-number image 1229 are shown to reside in main memory 1220, those skilled in the art will recognize that these items are not necessarily all completely contained in main memory 1220 at the same time. It should also be noted that the term “memory” is used herein to generically refer to the entire virtual memory of computer system 1200, and may include the virtual memory of other computer systems coupled to computer system 1200.

Data 1222 represents any data that serves as input to or output from any program in computer system 1200. Operating system 1224 is a multitasking operating system, such a Windows operating system available from Microsoft Corporation; however, those skilled in the art will appreciate that the spirit and scope of the present invention is not limited to any one operating system.

Processor 1210 may be constructed from one or more microprocessors and/or integrated circuits. Processor 1210 executes program instructions stored in main memory 1220. Main memory 1220 stores programs and data that processor 1210 may access. When computer system 1200 starts up, processor 1210 initially executes the program instructions that make up operating system 1224. Operating system 1224 is a sophisticated program that manages the resources of computer system 1200. Some of these resources are processor 1210, main memory 1220, mass storage interface 1230, display interface 1240, network interface 1250, and system bus 1260.

Although computer system 1200 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 1210. However, those skilled in the art will appreciate that the present invention applies equally to computer systems that simply use I/O adapters to perform similar functions.

Display interface 1240 is used to directly connect one or more displays 1265 to computer system 1200. These displays 1265, which may be non-intelligent (i.e., dumb) terminals, monitors, or fully programmable workstations, are used to allow system administrators and users to communicate with computer system 1200. Note, however, that while display interface 1240 is provided to support communication with one or more displays 1265, computer system 1200 does not necessarily require a display 1265, because all needed interaction with users and other processes may occur via network interface 1250.

Network interface 1250 is used to connect other computer systems and/or workstations (e.g., 1275 in FIG. 12) to computer system 1200 across a network 1270. The present invention applies equally no matter how computer system 1200 may be connected to other computer systems and/or workstations, regardless of whether the network connection 1270 is made using present-day analog and/or digital techniques or via some networking mechanism of the future. In addition, many different network protocols can be used to implement a network. These protocols are specialized computer programs that allow computers to communicate across network 1270. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of signal bearing media used to actually carry out the distribution. Examples of suitable signal bearing media include: recordable type media such as floppy disks (e.g., 1295 of FIG. 12) and CD ROM, and transmission type media such as digital and analog communications links.

The preferred embodiments provide an apparatus and methods for processing a digital image and generating therefrom a new image, preferably a paint-by-number image. In addition, the preferred embodiments provide a program product that includes the image processor 1226 of FIG. 12 on signal bearing media. The preferred embodiments also extend to methods for doing business using the method and program product of the preferred embodiments.

While the invention has been particularly shown and described with reference to preferred embodiments thereof, it will be understood by those skilled in the art that various changes in form and details may be made therein without departing from the spirit and scope of the invention.

1. An apparatus comprising:
at least one processor;
a memory coupled to the at least one processor;
a digital image residing in the memory; and
an image processor residing in the memory and executed by the at least one processor, the image processor processing the digital image according to a set of selected colors and generating a new image that includes outlines of regions in the digital image that correspond to the set of selected colors, the image processor marking at least one outline in the new image with at least one character that indicates which of the selected colors should be used in the at least one outline.

2. The apparatus of claim 1 wherein the image processor comprises a display mechanism that allows a user to change the set of selected colors and view the effect of the change on a display of the new image.

3. The apparatus of claim 1 wherein the new image comprises a paint-by-number image.

4. The apparatus of claim 1 further comprising a legend that correlates the at least one character to a corresponding color in the set of selected colors.

5. The apparatus of claim 4 wherein the legend is included in the new image.

6. The apparatus of claim 1 wherein the set of selected colors is selected one at a time by a user.

7. The apparatus of claim 1 wherein the set of selected colors is selected by a user selecting a predefined set of selected colors.

8. The apparatus of claim 7 wherein the predefined set of selected colors corresponds to colors in a pallette in a computer software paint program.

9. The apparatus of claim 7 wherein the predefined set of selected colors corresponds to colors of paint in a paint set.

10. The apparatus of claim 7 wherein the predefined set of selected colors corresponds to colors of crayons in a crayon set.

11. The apparatus of claim 7 wherein the predefined set of selected colors corresponds to colors of colored markers in a colored marker set.

12. The apparatus of claim 7 wherein the predefined set of selected colors corresponds to colors of colored pencils in a colored pencil set.

13. An apparatus comprising:
at least one processor;
a memory coupled to the at least one processor;
a digital image residing in the memory; and
an image processor residing in the memory and executed by the at least one processor, the image processor processing the digital image according to a predefined set of selected colors and generating a paint-by-number image that includes outlines of regions in the digital image that correspond to the set of selected colors, the image processor marking at least one outline in the paint-by-number image with at least one character that indicates which of the selected colors should be used in the at least one outline, the paint-by-number image including a legend that correlates the at least one character to a corresponding color in the predefined set of selected colors, the image processor including a display mechanism that allows a user to change the set of selected colors and view the effect of the change on a display of the paint-by-number image.

14. A method for processing a selected digital image and generating therefrom a new image comprising the steps of:
selecting a set of colors;
processing the digital image to divide the digital image into a plurality of regions that correspond to the set of defined colors;
creating a blank new image;
outlining in the new image each of the plurality of regions; and
marking at least one of the plurality of regions with at least one character that corresponds to one color in the selected set of colors.

15. The method of claim 14 further comprising the steps of:
allowing a user to change the selected set of colors; and
displaying the effect of the change on a display of the new image.

16. The method of claim 14 wherein the new image comprises a paint-by-number image.

17. The method of claim 14 further comprising the step of generating a legend that correlates the at least one character to a corresponding color in the set of selected colors.

18. The method of claim 17 further comprising the step of including the legend in the new image.

19. The method of claim 14 wherein the step of selecting the set of colors is performed by a user selecting each color in the set of selected colors one at a time.

20. The method of claim 14 wherein the step of selecting the set of colors is performed by a user selecting a predefined set of selected colors.

21. The method of claim 20 wherein the predefined set of selected colors corresponds to colors in a pallette in a computer software paint program.

22. The method of claim 20 wherein the predefined set of selected colors corresponds to colors of paint in a paint set.

23. The method of claim 20 wherein the predefined set of selected colors corresponds to colors of crayons in a crayon set.

24. The method of claim 20 wherein the predefined set of selected colors corresponds to colors of colored markers in a colored marker set.

25. The method of claim 20 wherein the predefined set of selected colors corresponds to colors of colored pencils in a colored pencil set.

26. A method for processing a digital image and generating therefrom a paint-by-number image comprising the steps of:
selecting a predefined set of colors;
processing the digital image to divide the digital image into a plurality of regions that correspond to the selected set of colors;
creating a blank paint-by-number image;
outlining in the paint-by-number image each of the plurality of regions in the digital image;
marking at least one of the plurality of regions in the paint-by-number image with at least one character that corresponds to a color in the selected set of colors;
allowing a user to change the selected set of colors;
displaying the effect of the change on a display of the paint-by-number image;
generating a legend that correlates the at least one character to a corresponding color in the set of selected colors; and
including the legend in the paint-by-number image.

27. A program product comprising:
an image processor residing in the memory and executed by the at least one processor, the image processor processing the digital image according to a set of selected colors and generating a new image that includes outlines of regions in the digital image that correspond to the set of selected colors, the image processor marking at least one outline in the new image with at least one character that indicates which of the selected colors should be used in the at least one outline; and
computer-readable signal bearing media bearing the image processor.

28. The program product of claim 27 wherein the computer-readable signal bearing media comprises recordable media.

29. The program product of claim 27 wherein the computer-readable signal bearing media comprises transmission media.

30. The program product of claim 27 wherein the image processor comprises a display mechanism that allows a user to change the set of selected colors and view the effect of the change on a display of the new image.

31. The program product of claim 27 wherein the new image comprises a paint-by-number image.

32. The program product of claim 27 further comprising a legend that correlates the at least one character to a corresponding color in the set of selected colors.

33. The program product of claim 32 wherein the legend is included in the new image.

34. The program product of claim 27 wherein the set of selected colors is selected one at a time by a user.

35. The program product of claim 27 wherein the set of selected colors is selected by a user selecting a predefined set of selected colors.

36. The program product of claim 35 wherein the predefined set of selected colors corresponds to colors in a pallette in a computer software paint program.

37. The program product of claim 35 wherein the predefined set of selected colors corresponds to colors of paint in a paint set.

38. The program product of claim 35 wherein the predefined set of selected colors corresponds to colors of crayons in a crayon set.

39. The program product of claim 35 wherein the predefined set of selected colors corresponds to colors of colored markers in a colored marker set.

40. The program product of claim 35 wherein the predefined set of selected colors corresponds to colors of colored pencils in a colored pencil set.

41. A program product comprising:
an image processor that processes a digital image according to a set of selected colors and generates a paint-by-number image that includes outlines of regions in the digital image that correspond to the set of selected colors, the image processor marking at least one outline in the paint-by-number image with at least one character that indicates which of the selected colors should be used in the at least one outline, the paint-by-number image including a legend that correlates the at least one character to a corresponding color in the predefined set of selected colors, the image processor including a display mechanism that allows a user to change the set of selected colors and view the effect of the change on a display of the paint-by-number image; and
computer-readable signal bearing media bearing the image processor.

42. The program product of claim 41 wherein the computer-readable signal bearing media comprises recordable media.

43. The program product of claim 41 wherein the computer-readable signal bearing media comprises transmission media.

44. A method for doing business comprising the steps of:
receiving a customer-selected digital image;
receiving a customer-selected set of colors;
processing the customer-selected digital image to divide the customer-selected digital image into a plurality of regions that correspond to the customer-selected set of colors;
creating a new blank image;
creating an outline of each of the plurality of regions in the customer-selected digital image in the new image;
marking at least one outlined region in the new image with at least one character that corresponds to one of the customer-selected colors; and
outputting the new image to the customer.

45. A method for doing business comprising the steps of:
generating the program product of claim 27; and
selling a product that includes a set of colors for coloring a picture in combination with the program product, the set of colors in the product defining the set of selected colors for the program product.

46. The method of claim 45 wherein the product comprises a computer software paint program.

47. The method of claim 45 wherein the product comprises a paint set.

48. The method of claim 45 wherein the product comprises a crayon set.

49. The method of claim 45 wherein the product comprises a colored marker set.

50. The method of claim 45 wherein the product comprises a colored pencil set.
